(19) United States
(12) Patent Application Publication
(10) Pub. No.: US 2023/0119705 A1
(43) Pub. Date: Apr. 20, 2023

(54) VEHICLE AIR CONDITIONER

(71) Applicant: Hanon Systems, Daejeon (KR)

(72) Inventors: Yo Chan MIN, Daejeon (KR); Jae-Chun YOU, Daejeon (KR); Tae Yong PARK, Daejeon (KR)

(73) Assignee: Hanon Systems, Daejeon (KR)

(21) Appl. No.: 17/909,577

(22) PCT Filed: Mar. 5, 2021
(86) PCT No.: PCT/KR2021/002780

§ 371 Date: Sep. 6, 2022

(30) Foreign Application Priority Data
Mar. 6, 2020 (KR) 10-2020-0028296

(51) Int. Cl. B60H 1/00

(52) U.S. Cl. CPC B60H 1/00028; B60H 1/00521; B60H 1/00542; B60H 1/00842; B60H 3/0608

(57) ABSTRACT

A vehicle air conditioner, and more specifically, to a vehicle air conditioner in which an air conditioning module and a cooling module are integrally formed, thereby enabling miniaturization so as to enable increased space utilization inside an engine room, and enabling increased manufacturability.

### TECHNICAL FIELD

The present invention relates to a vehicle air conditioner, and more specifically, to a vehicle air conditioner which may have a smaller size by including an air conditioning module and a cooling module integrally formed with each other, and thus have increased space utilization in an engine room and further enhanced manufacturability.

### BACKGROUND ART

A typical vehicle air conditioner system may include the followings connected by a refrigerant pipe: a compressor compressing and delivering a refrigerant, a condenser condensing the high-pressure refrigerant delivered from the compressor, an expansion means throttling the refrigerant condensed and liquefied by the condenser, and an evaporator evaporating the low-pressure liquid refrigerant throttled by the expansion means by exchanging heat with air blown to a vehicle interior, to cool air discharged into the vehicle interior by using heat absorption by latent heat released when the refrigerant is evaporated, and the like.

The evaporator may be installed in an air conditioning case installed in the vehicle interior and serve to cool the interior. That is, the vehicle interior may be cooled when air blown by a blower is cooled by the latent heat which is released when the liquid refrigerant circulated in the evaporator is evaporated, while passing through the evaporator, and the cold air is discharged into the vehicle interior.

In addition, the vehicle interior may be heated using a heater core which is installed in the air conditioning case and in which an engine coolant is circulated, or an electric heating type heater installed in the air conditioning case.

Meanwhile, the condenser may be installed at a front portion of a vehicle to dissipate heat while exchanging heat with air.

In recent years, a heat pump system that performs air cooling and heating by using only a refrigeration cycle has been developed. As shown in FIG. 1, the heat pump system may include a cold air passage 11 and a hot air passage 12 which are partitioned in one air conditioning case 10, an evaporator 4 for air cooling which is installed in the cold air passage 11 and a condenser 2 for air heating which is installed in the hot air passage 12. Here, an air outlet 15 for supplying air to the vehicle interior and an air discharge 16 for discharging air to a vehicle exterior may be positioned at an outlet of the air conditioning case 10. In addition, blowers 20 individually operated may respectively be installed at inlets of the cold air passage 11 and the hot air passage 12.

Therefore, in an air cooling mode, cold air cooled while passing through the evaporator 4 of the cold air passage 11 may be discharged to the vehicle interior through the air outlet 15 to cool the interior. Here, hot air heated while passing through the condenser 2 of the hot air passage 12 may be discharged to the vehicle exterior through the air discharge 16.

In an air heating mode, hot air heated while passing through the condenser 2 of the hot air passage 12 may be discharged to the vehicle interior through the air outlet 15 to heat the interior. Here, cold air cooled while passing through the evaporator 4 of the cold air passage 11 may be discharged to the vehicle exterior through the air discharge 16.

However, in the prior art, the blowers 20 may respectively be positioned in the cold air passage 11 and the hot air passage 12, air passing through the condenser 2 or the evaporator 4 may be required to be discharged through the air discharge based on an air cooling or heating setting, and the air discharge 16 equipped with a control door may thus be inevitably positioned in each of two places. Therefore, the heat pump system may inevitably have an increased overall size.

In addition, the condenser 2 installed in the air conditioning case may have a low condensing performance due to its inevitably small size. Therefore, the heat pump system may have a problem with its cooling performance.

Meanwhile, a front end module including a carrier, a cooling module and a headlamp may be positioned at a front portion of the vehicle. The cooling module may include a radiator, a condenser and a fan shroud, and heat may be exchanged between the radiator and the condenser through wind blown from the front of the vehicle.

Accordingly, required is a process for individually assembling the air conditioner and the cooling module to each other, and regions where the air conditioner is installed to actually perform air conditioning and the condenser of the cooling module is installed may be far away from each other, and may thus be connected to each other through a refrigerant line.

In recent years, a variety of new types of vehicles have been proposed, and in particular, there is an increasing demand for a method for effectively utilizing a space in an engine room.

### RELATED ART DOCUMENT

### Patent Document

Patent Document 1: Korean Patent No. 10-1251206 (entitled, “AIR-CONDITIONER WITHOUT STARTING THE ENGINE FOR VEHICLE”)

### DISCLOSURE

### Technical Problem

An object of the present invention is to provide a vehicle air conditioner which may have a smaller size by including an air conditioning module and a cooling module integrally formed with each other to have increased space utilization in an engine room and further enhanced manufacturability.

Another object of the present invention is to provide a vehicle air conditioner in which exterior air introduced through an exterior air inlet may be supplied while being divided into air flowing to an air conditioning module and air flowing to a cooling module, and which may control flows of interior air and exterior air supplied to the air conditioning module by using an interior/exterior air controller.

Still another object of the present invention is to provide a vehicle air conditioner in which an air conditioning module has a first region and a second region positioned parallel to each other to have increased space utility and smoothly air-condition a vehicle interior, the first region being provided for blowing air in a width direction and the second region being provided with an evaporator for air cooling and a heat exchanger for air heating.

Yet another object of the present invention is to provide a vehicle air conditioner in which a cooling module is positioned in an entire region of an outer case (or all the first and second regions of an air conditioning module) in a width direction to sufficiently secure heat exchange performance of a radiator.

Still yet another object of the present invention is to provide a vehicle air conditioner in which a cooling module includes an exterior heat exchanger (i.e. condenser or variable heat exchanger) to minimize a refrigerant pipe, an exterior heat exchanger is adjacent and parallel to a radiator at a position correspond to a second region in a width direction, and exterior air and engine-room air selectively pass through the air conditioner to have increased air cooling and heating efficiency.

### Technical Solution

In one general aspect, a vehicle air conditioner 1000 includes: an air conditioning module M1 for cooling and heating a vehicle interior; and a cooling module M2 including a radiator 720 and a fan shroud 710 that forms a flow of air passing through the radiator 720, wherein some of exterior air introduced from a lower side of the air conditioning module M1 to one side in the length direction passes through the cooling module M2 positioned at the other side in the length direction.

In addition, the vehicle air conditioner 1000 may be configured of: an outer case 110 including a through exterior air inlet 210 for introducing exterior air into the air conditioning module M1 and the cooling module M2, a through interior air inlet 220 for introducing interior air into the air conditioning module M1, and an air delivery part 240 for delivering air for cooling and heating the vehicle interior; and an inner case 120 positioned in the outer case 110 to position the air conditioning module M1 therein.

In addition, the air conditioning module M1 may have a first region 101 and a second region 102 positioned parallel to each other in the width direction, the first region 101 being provided with an interior/exterior air controller 230 for selectively supplying exterior air introduced through the exterior air inlet 210 and interior air introduced through the interior air inlet 220, and a blower 400 for blowing air to the air conditioning module M1; and the second region 102 being provided with an evaporator 510 for air cooling and a heat exchanger 520 for air heating to exchange heat with air supplied from the first region 101 and then supply heat-exchanged air through the air delivery part 240.

In addition, in the vehicle air conditioner 1000, the interior air inlet 220 and the air delivery part 240 may be positioned on an upper side of the outer case 110 while being parallel to each other in the width direction.

In addition, the cooling module M2 may be positioned in an entire region of the outer case 110 in the width direction.

In addition, the interior/exterior air controller 230 may include a first through portion 210a which is a certain through region of the inner case 120 for introducing some of exterior air introduced through the exterior air inlet 210 into the first region 101, the interior air inlet 220, and a first control door 231 for controlling flows of exterior air and interior air respectively introduced through the first through portion 210a and the interior air inlet 220.

In addition, the air conditioning module M1 may include a filter 300 positioned between the interior/exterior air controller 230 and the blower 400 in the first region 101.

In addition, the cooling module M2 may include an exterior heat exchanger 730.

In addition, in the vehicle air conditioner 1000, the exterior heat exchanger 730 may be positioned to correspond to the second region 102 in the width direction while being above, adjacent and parallel to the radiator 720.

In addition, the cooling module M2 may be mounted while having a certain upper region inclined to the other side in the length direction.

In addition, the vehicle air conditioner may include a second through portion 210b, an engine-room air inlet 250 and a second control door 251 to control air supplied to the exterior heat exchanger 730, the second through portion 210b being a certain through region of the inner case 120 for introducing some of exterior air introduced through the exterior air inlet 210 into the cooling module M2; the engine-room air inlet 250 introducing air inside the engine room; and the second control door 251 controlling flows of exterior air and engine-room air which are respectively introduced through the second through portion 210b and the engine room air inlet 250.

In addition, in the vehicle air conditioner 1000, the engine-room air inlet 250 may be positioned parallel to the air delivery part 240 in the length direction.

In addition, in the vehicle air conditioner 1000, a step portion 121 having a stepped shape may be positioned on a bottom side of the inner case 120 in the second region 102.

In addition, in the air conditioning module M1, the evaporator 510 and the heat exchanger 520 are positioned parallel to each other in the height direction.

In addition, the vehicle air conditioner 1000 may further include an auxiliary heating heat exchanger 530 positioned at the rear of the heat exchanger 520 in an air flow direction.

### Advantageous Effects

As set forth above, the vehicle air conditioner according to the present invention may have a smaller size by including the air conditioning module and the cooling module integrally formed with each other to have the increased space utilization in the engine room and the further enhanced manufacturability.

In addition, in the vehicle air conditioner according to the present invention, the exterior air introduced through the exterior air inlet may be supplied while being divided into air flowing to the air conditioning module and air flowing to the cooling module, and the air conditioner may control the flows of the interior air and the exterior air supplied to the air conditioning module by using the interior/exterior air controller.

In addition, in the vehicle air conditioner according to the present invention, the air conditioning module has the first region and the second region positioned parallel to each other to have the increased space utility and smoothly air-condition the vehicle interior, the first region being provided for blowing air in a width direction and the second region being provided with the evaporator for air cooling and the heat exchanger for air heating.

In addition, in the vehicle air conditioner according to the present invention, the cooling module may be positioned in the entire region of the outer case (or all the first and second regions of the air conditioning module) in the width direction, and the air conditioner may thus sufficiently secure the heat exchange performance of the radiator.

In addition, in the vehicle air conditioner according to the present invention, the cooling module may include the exterior heat exchanger (i.e. condenser or variable heat exchanger) to minimize the refrigerant pipe, the exterior heat exchanger may be positioned to correspond to the second region in the width direction while being adjacent and parallel to the radiator, and the exterior air and the engine-room air may selectively pass through the air conditioner to have increased air cooling and heating efficiency.

### DESCRIPTION OF DRAWINGS

FIG. 1 is a view showing a prior vehicle heat pump system.

FIG. 2 is a perspective view of a vehicle air conditioner according to the present invention.

FIG. 3 is a transmission perspective view of the vehicle air conditioner according to the present invention.

FIGS. 4 and 5 are views respectively taken along direction AA′ and direction BB′ of the vehicle air conditioner according to the present invention.

FIG. 6 is a view showing flows of interior air and exterior air of the vehicle air conditioner according to the present invention.

FIG. 7 is another cross-sectional view of a vehicle air conditioner according to the present invention.

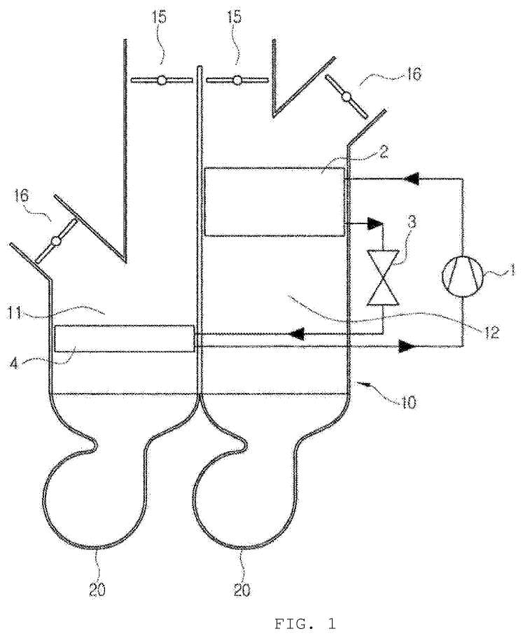

### BEST MODE

Hereinafter, a vehicle air conditioner 1000 having the configuration as described above will be described in detail with reference to the accompanying drawings.

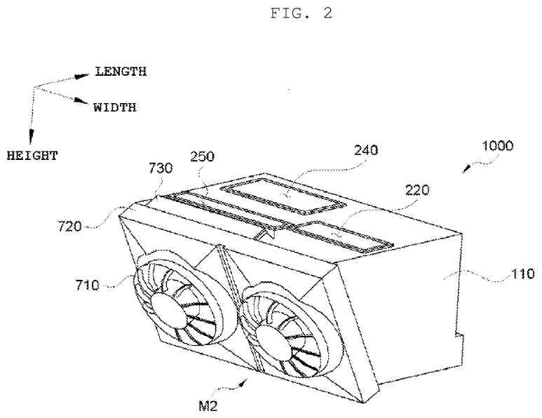

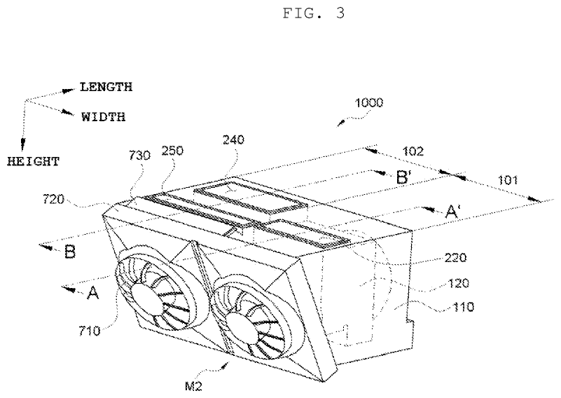

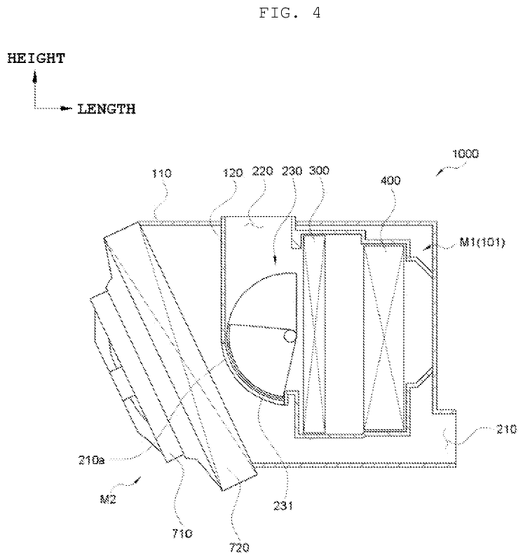

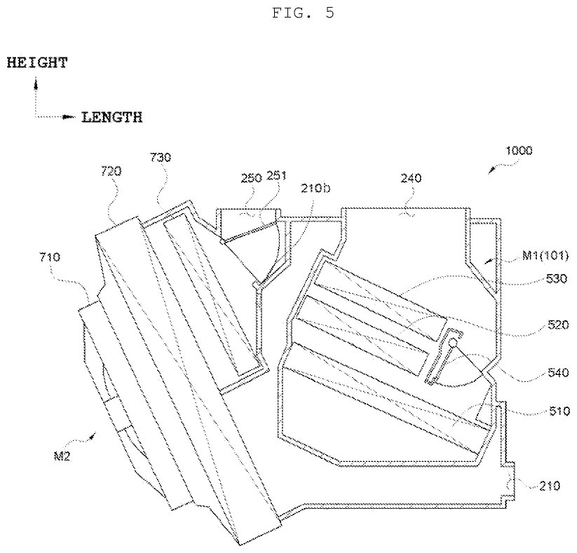

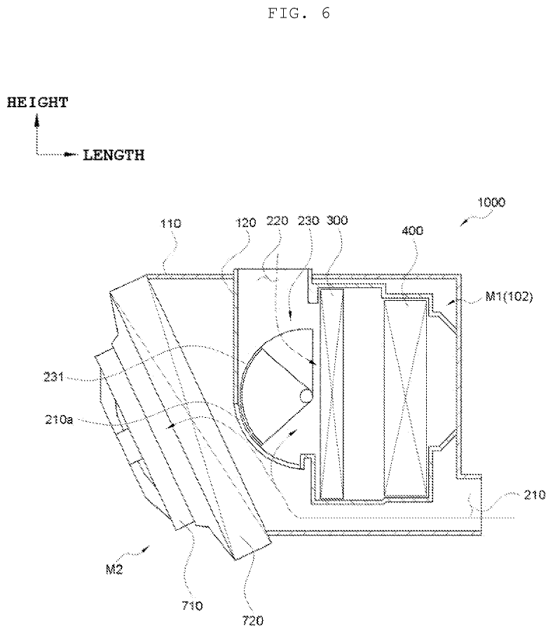

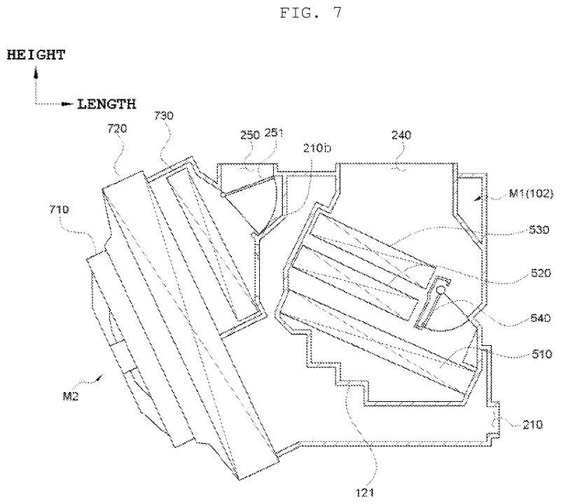

FIG. 2 is a perspective view of a vehicle air conditioner 1000 according to the present invention; FIG. 3 is a transmission perspective view of the vehicle air conditioner 1000 according to the present invention; FIGS. 4 and 5 are views respectively taken along direction AA′ and direction BB′ of the vehicle air conditioner according to the present invention; FIG. 6 is a view showing flows of interior air and exterior air of the vehicle air conditioner according to the present invention; and FIG. 7 is another cross-sectional view of a vehicle air conditioner according to the present invention.

In the vehicle air conditioner 1000 of the present invention, an air conditioning module M1 and a cooling module M2 may be integrally formed with each other and positioned in a vehicle engine room.

First, the air conditioning module M1 may be a component for cooling and heating a vehicle interior, and the cooling module M2 may be a component including a radiator 720 and a fan shroud 710 that forms a flow of air passing through the radiator 720. Accordingly, the vehicle air conditioner 1000 of the present invention may not require a process or space for separately mounting the cooling module M2 because the cooling module M2, which is supposed to be conventionally positioned at a front portion of the vehicle, may be mounted on the air conditioner together with the air conditioning module M1 integrally formed therewith.

In the radiator 720, a coolant for cooling an engine may flow, and a coolant for cooling various electronic components positioned in the engine room may flow.

In more detail, the vehicle air conditioner 1000 of the present invention may be configured of an outer case 110 and an inner case 120.

The outer case 110 may be an external basic body of the vehicle air conditioner 1000, and include an external air inlet 210, an interior air inlet 220 and an air delivery part 240.

The exterior air inlet 210 may be a space which is a certain through region of the outer case 110 for introducing exterior air, and air introduced through the exterior air inlet 210 may be supplied to the air conditioning module M1 and the cooling module M2.

The interior air inlet 220 may be a space in which a certain through region of the outer case 110 for introducing interior air, and the interior air may be introduced into the air conditioning module M1.

Here, the exterior air inlet 210 may be positioned on a lower side of the air conditioner in the height direction.

Exterior air may thus be introduced into the outer case 110 while being delivered in the length direction, some of exterior air may pass through the cooling module M2, and the rest may be selectively supplied to the air conditioning module M1. That is, in the cooling module M2, exterior air may be introduced into a region between the outer case 110 and the inner case 120 by the exterior air inlet 210 positioned in the lower side of the air conditioner in the height direction and simultaneously in one side thereof in the length direction, and pass through the cooling module M2 to be discharged to the other side of the air conditioner in the length direction. In other words, exterior air introduced through the exterior air inlet 210 may pass by an operation of the fan shroud 710 to exchange heat with the coolant in the radiator 720.

(In FIG. 6, a flow of the exterior air is indicated by a solid arrow, and a flow of the interior air is indicated by a dotted arrow).

The cooling module M2 may be positioned in an entire region of the outer case 110 in the width direction to sufficiently secure heat exchange performance of the radiator 720. To this end, the exterior air inlet 210 may also be positioned long in the width direction.

Here, the air conditioning module M1 may be used by introducing exterior air introduced through the exterior air inlet 210 thereinto. That is, the air conditioning module M1 may cool or heat the interior by exchanging heat with exterior air or interior air each introduced through the exterior air inlet 210 or the interior air inlet 220. The flows of exterior air and interior air which are introduced into the air conditioning module M1 may be controlled by an interior/exterior air controller 230, and a specific configuration thereof is described again below.

The air delivery part 240 may be a certain through region of the outer case 110 for delivering air heat-exchanged in the air conditioning module M1 (or air for cooling the vehicle interior).

Here, the interior air inlet 220 and the air delivery part 240 may be positioned in an upper side of the outer case 110 while being parallel to each other in the width direction.

The inner case 120 may be a space partitioned from the outer case 110 to position the air conditioning module M1 therein, and in which components for allowing air to be introduced into the air conditioning module M1, an evaporator 510 for air cooling, a heat exchanger 520 for air heating, and the like may be built.

That is, the air conditioning module M1 positioned in the inner case 120 may have a first region 101 and a second region 102 positioned parallel to each other in the width direction.

The first region 101 may be provided with an interior/exterior air controller 230 and a blower 400 to introduce exterior air or interior air into the air conditioning module M1.

The interior/exterior air controller 230 may include a first through portion 210a which is a certain through region of the inner case 120 for introducing some of exterior air introduced through the exterior air inlet 210 into the first region 101, the interior air inlet 220, and a first control door 231 for controlling the flows of exterior air and interior air respectively introduced through the first through portion 210a and the interior air inlet 220.

In vehicle air conditioner 1000, exterior air may pass through the cooling module M2 by being delivered from one side to the other side of a portion where the first region 101 is positioned in the length direction through the exterior air inlet 210 which is positioned below the inner case 120, i.e. in a region between the inner case 120 and the outer case 110. Some of exterior air may then be supplied into the first region 101 of the air conditioning module M1 through the first through portion 210a by an operation of the first control door 231 of the interior/exterior air controller 230.

The blower 400 may introduce exterior air or interior air into the air conditioning module M1.

In addition, the air conditioning module M1 may include a filter 300 positioned between the interior/exterior air controller 230 and the blower 400 of the first region 101, and the filter 300 may have a form enabling the filter to be replaced, a form enabling the filter to electrically collect dust or the like, and is not limited to any particular form.

The second region 102 may be provided with an evaporator 510 for air cooling and a heat exchanger 520 for air heating to exchange heat with air supplied from the first region 101 and then supply heat-exchanged air through the air delivery part 240.

The evaporator 510 may cool air discharged to the vehicle interior through the air delivery part 240. Here, when the air cooling is performed, a refrigerant in a wet state of low temperature and low pressure may be supplied to the evaporator 510, and air may be cooled while passing through the evaporator 510 to be discharged to the vehicle interior. On the other hand, when the air heating is performed, the refrigerant may not be supplied to the evaporator 510, such that even though air passes through the evaporator 510, a temperature may not be changed.

The heat exchanger 520 may heat air discharged to the vehicle interior through the air delivery part 240. Here, the heat exchanger 520 may be a heater core to which a heated coolant is supplied, or may be the interior heat exchanger 520 of a heat pump system.

Here, the second region 102 may further be provided with a temp door 540 that determines whether air-conditioning air passing through the evaporator 510 passes through the heat exchanger 520.

The evaporator 510 and the heat exchanger 520 may be positioned parallel to each other in the height direction, and air conditioning air may thus be moved from a lower side of the inner case 120 to its upper side by an operation of the temp door 540 to pass through only the evaporator 510(in the air cooling) or, sequentially pass through the evaporator 510 and then the heat exchanger 520 (in the air heating).

The vehicle air conditioner 1000 of the present invention may further include an auxiliary heating heat exchanger 530 positioned at the rear of the heat exchanger 520 in the air flow direction. The auxiliary heating heat exchanger 530 may be a component performing the air heating together with the heat exchanger 520, and use various types including a positive temperature coefficient (PTC) heating means. The auxiliary heating heat exchanger 530 may also be positioned parallel to the heat exchanger 520, and may be positioned above and parallel to the heat exchanger 520 positioned at a rear portion of the air conditioner in the air flow direction.

In the vehicle air conditioner 1000 of the present invention, the cooling module M2 may further include an exterior heat exchanger 730.

In the present invention, the exterior heat exchanger 730 may refer to another heat exchanger 520 positioned outside the inner case 120, and may be a condenser for the air cooling performed by the evaporator 510 while the refrigerant sequentially passes through the compressor, the condenser, the expansion means, and then the evaporator 510.

Alternatively, the exterior heat exchanger 730 may be a variable heat exchanger 520 whose role in the heat pump system is variable. The variable exterior heat exchanger 730 may not be a component for cooling or heating air for the actual cooling and heating, and may condense the refrigerant supplied to the evaporator 510 based on an air cooling setting, or evaporate the refrigerant supplied to the heat exchanger 520 based on an air heating setting.

The exterior heat exchanger 730 may be positioned in an upper region of the air conditioner while being adjacent and parallel to the radiator 720, and positioned to correspond to the second region 102, where the blower 400 having a relatively large size is not positioned. That is, the exterior heat exchanger 730 may be positioned below the inner case 120, and may also be mounted in the header tank of the radiator 720 or the fan shroud 710 of the cooling module M2, as in the prior art, or may be mounted in the inner case 120 or the outer case 110.

Here, the cooling module M2 may be mounted while having a certain upper region inclined to the other side in the length direction to secure a space where the exterior heat exchanger 730 is installed.

When including the exterior heat exchanger 730 positioned therein, the air conditioner may include a second through portion 210b which is a certain through region of the inner case 120 for introducing some of exterior air introduced through the exterior air inlet 210 into the cooling module M2, an engine-room air inlet 250, and a second control door 251 for controlling the flows of exterior air and engine-room air which are respectively introduced through the second through portion 210b and the engine-room air inlet 250 so that air inside the engine room selectively passes through the exterior heat exchanger 730 and the radiator 720 sequentially.

The engine-room air inlet 250 may be a through portion positioned in the upper side of the outer case 110 for introducing engine-room air therein and parallel to the air delivery part 240 in the length direction, and the second control door 251 may selectively control an opening degree of the engine-room air inlet 250 and the exterior air inlet 210.

That is, the exterior air inlet 210 may be positioned over the first region 101 and the second region 102 to be long in the width direction. Exterior air introduced through the exterior air inlet 210 positioned to correspond to the first region 101 may be supplied to the cooling module M2 or the air conditioning module M1. Here, some of exterior air introduced through the exterior air inlet 210 positioned to correspond to the second region 102 may pass through a region where the exterior heat exchanger 730 is not positioned, and the rest may pass through the exterior heat exchanger 730 and the radiator 720 sequentially.

In particular, in the winter when the exterior temperature is low, air inside the engine room may be heated by operations of various electronic components and maintain a temperature higher than the exterior temperature. As such, the engine-room air inlet 250 and the second control door 251 may be positioned in the vehicle air conditioner 1000 of the present invention and supply air inside the engine room into the outer case 110 to increase evaporation performance (or heat absorption amount) of the exterior heat exchanger 730, thus further increasing the air heating performance of the heat exchanger 520.

As shown in FIG. 7, in the vehicle air conditioner 1000, a step portion 121 having a stepped shape may be positioned on a bottom side of the inner case 120 in the second region 102.

The step portion 121 may be a portion positioned on the bottom side of the inner case 120 in the second region 102 for exterior air introduced through the exterior air inlet 210 to be uniformly supplied to the exterior heat exchanger 730 and the radiator 720. That is, the step portion 121 can increase uniformity of air (or exterior air) supplied to the radiator 720 by increasing a space through which exterior air is delivered and allowing exterior air to be uniformly supplied to an entire region of the radiator 720.

As described above, the vehicle air conditioner 1000 of the present invention can have a smaller size by including the air conditioning module M1 and the cooling module M2 integrally formed with each other, have further enhanced manufacturability, smoothly air-condition the vehicle interior, and easily cool the electronic components and the like.

The present invention is not limited to the above-mentioned embodiments, and may be variously applied. In addition, the present invention may be variously modified by those skilled in the art to which the present invention pertains without departing from the gist of the present invention claimed in the claims.

### DESCRIPTION OF REFERENCE NUMERALS

1000: vehicle air conditioner, 101: first region, 102: second region,

110: outer case, 120: inner case, 121: step portion,

M1: air conditioning module, 210: exterior air inlet, 210a: first through portion,

210b: second through portion, 220: interior air inlet, 230: interior/exterior air controller,

231: first control door, 240: air delivery part, 250: engine-room air inlet,

251: second control door, 300: filter, 400: blower,

510: evaporator, 520: heat exchanger, 530: auxiliary heating heat exchanger,

540: temp door, M2: cooling module, 710: fan shroud,

720: radiator, 730: exterior heat exchanger

1. A vehicle air conditioner comprising:
an air conditioning module for cooling and heating a vehicle interior; and
a cooling module including a radiator and a fan shroud that forms a flow of air passing through the radiator,
wherein some of exterior air introduced from a lower side of the air conditioning module to one side in the length direction passes through the cooling module positioned at the other side in the length direction.

2. The vehicle air conditioner of claim 1, wherein the vehicle air conditioner is configured of:
an outer case including a through exterior air inlet for introducing exterior air into the air conditioning module and the cooling module, a through interior air inlet for introducing interior air into the air conditioning module, and an air delivery part for delivering air for cooling and heating the vehicle interior; and
an inner case positioned in the outer case to position the air conditioning module therein.

3. The vehicle air conditioner of claim 2, wherein the air conditioning module has a first region and a second region positioned parallel to each other in the width direction,
the first region being provided with an interior/exterior air controller for selectively supplying exterior air introduced through the exterior air inlet and interior air introduced through the interior air inlet, and a blower for blowing air to the air conditioning module; and
the second region being provided with an evaporator for air cooling and a heat exchanger for air heating to exchange heat with air supplied from the first region and then supply heat-exchanged air through the air delivery part.

4. The vehicle air conditioner of claim 3, wherein in the vehicle air conditioner, the interior air inlet and the air delivery part are positioned on an upper side of the outer case while being parallel to each other in the width direction.

5. The vehicle air conditioner of claim 3, wherein the cooling module is positioned in an entire region of the outer case in the width direction.

6. The vehicle air conditioner of claim 3, wherein the interior/exterior air controller includes
a first through portion a which is a certain through region of the inner case for introducing some of exterior air introduced through the exterior air inlet into the first region,
the interior air inlet, and
a first control door for controlling flows of exterior air and interior air respectively introduced through the first through portion a and the interior air inlet.

7. The vehicle air conditioner of claim 6, wherein the air conditioning module includes a filter positioned between the interior/exterior air controller and the blower in the first region.

8. The vehicle air conditioner of claim 4, wherein the cooling module includes an exterior heat exchanger.

9. The vehicle air conditioner of claim 8, wherein in the vehicle air conditioner, the exterior heat exchanger is positioned to correspond to the second region in the width direction while being above, adjacent and parallel to the radiator.

10. The vehicle air conditioner of claim 9, wherein the cooling module is mounted while having a certain upper region inclined to the other side in the length direction.

11. The vehicle air conditioner of claim 9, comprising a second through portion, an engine-room air inlet and a second control door to control air supplied to the exterior heat exchanger,
the second through portion being a certain through region of the inner case for introducing some of exterior air introduced through the exterior air inlet into the cooling module;
the engine-room air inlet introducing air inside the engine room; and
the second control door controlling flows of exterior air and engine-room air which are respectively introduced through the second through portion and the engine room air inlet.

12. The vehicle air conditioner of claim 11, wherein in the vehicle air conditioner, the engine-room air inlet is positioned parallel to the air delivery part in the length direction.

13. The vehicle air conditioner of claim 11, wherein in the vehicle air conditioner, a step portion having a stepped shape is positioned on a bottom side of the inner case in the second region.

14. The vehicle air conditioner of claim 3, wherein in the air conditioning module, the evaporator and the heat exchanger are positioned parallel to each other in the height direction.

15. The vehicle air conditioner of claim 14, further comprising an auxiliary heating heat exchanger positioned at the rear of the heat exchanger in an air flow direction.
